(19) United States
(12) Patent Application Publication
(10) Pub. No.: US 2016/0213022 A1
(43) Pub. Date: Jul. 28, 2016

(54) STACKABLE CONFECTION

(71) Applicant: INTERCONTINENTAL GREAT BRANDS LLC, East Hanover, NJ (US)

(72) Inventors: Gerald B. Cotten, Whippany, NJ (US); Simon R. Gainey, Media, PA (US); Thomas E. Wells, Chadds Fod, PA (US); Daniel Yaginuma, Sao Bernardo do Campo (BR); Roberto Antonio Fagaraz Junior, Bela Vista (BR)

(21) Appl. No.: 14/917,165

(22) PCT Filed: Sep. 16, 2014
(86) PCT No.: PCT/US14/55830

§ 371 Date: Mar. 7, 2016

Related U.S. Application Data
(60) Provisional application No. 61/878,408, filed on Sep. 16, 2013.

(51) Int. Cl. A23G 3/50

(52) U.S. Cl. CPC A23G 3/50

(57) ABSTRACT

Disclosed is a confection including a confection body including an upper surface and an opposing lower surface, and at least one upper surface indicium and at least one upper surface non-indicium area disposed at the upper surface, wherein an uppermost extent of the at least one upper surface indicium extends a substantially equal distance from the lower surface as an uppermost extent of the at least one upper surface non-indicium area.

### CROSS REFERENCE TO RELATED APPLICATIONS

This application is a National Stage application of PCT/US2014/055830, filed Sep. 16, 2014, which claims the benefit of U.S. Provisional Application No. 61/878,408, filed Sep. 16, 2013, both of which are incorporated by reference in their entirety herein.

### FIELD

The disclosure is generally directed to a confection, and more particularly directed to a confection that is stackable.

### BACKGROUND

Boiled confection such as hard candy and lozenges have been available on the market for decades. Such boiled confection can be found in the form of lollipops, candy cane, and the aforementioned lozenges. Following boiling of the confection blend to a target temperature, and then cooling of the confection blend to include a target viscosity, boiled confection is often shaped or molded into a desired form. Particularly in the case of lozenges, this form has often included indicium intended to indicate the brand being purchased.

One drawback of such indicium, however, is the lack of flat or level surface area that sometimes remains on a top or bottom surface of the lozenge when indicium is molded as a depression into the lozenge or raised to extend away from the body of the lozenge. This lack of flat or level surface area can be a drawback in that it limits the ability to stack the candies unless the candies include a specific design choice that is conducive to stacking (such as an indicium disposed within a depression of candy), or are specifically oriented relative to other candies in the stack (which can cause inefficiencies in production). This limitation on stacking is problematic when candies are contained in some common forms of stacked packaging. Moreover, design choices that may allow the confection to be produced more efficiently or be more appealing are sometimes avoided for stacking reasons. Accordingly, a boiled confection that allows more freedom of design choice without limiting options for stacking would be desirable.

### SUMMARY

Disclosed is a confection including a confection body including an upper surface and an opposing lower surface, and at least one upper surface indicium and at least one upper surface non-indicium area disposed at the upper surface, wherein an uppermost extent of the at least one upper surface indicium extends a substantially equal distance from the lower surface as an uppermost extent of the at least one upper surface non-indicium area.

Also disclosed is a confection including a confection body including an upper surface and an opposing lower surface, at least one upper surface concavity that is concave in a direction towards the lower surface, at least one upper surface convexity that is convex in a direction away from lower surface; and at least one upper surface indicium disposed at a plateau surface of the at least one upper surface convexity, the upper surface indicium including a length and a width, the length of the at least one indicium being oriented in a direction towards the at least one upper surface concavity, wherein the length of the at least one indicium is greater than the width of the at least one indicium.

Further disclosed is a confection including a confection body including an upper surface and an opposing lower surface, at least one upper surface concavity that is concave in a direction towards the lower surface, at least one upper surface convexity that is convex in a direction away from the lower surface, and at least one upper surface indicium disposed at a plateau surface of the at least one upper surface convexity, the at least one upper surface indicium including a length and a width, wherein the plateau surface includes level surfaces at areas disposed at opposite sides of the at least one upper surface indicium separated by the width of the at least upper surface one indicium.

Still further disclosed is a confection including a confection body including an upper surface and an opposing lower surface, at least one upper surface concavity that is concave in a direction towards the lower surface, at least one upper surface convexity that is convex in a direction away from the lower surface, and at least one upper plateau surface disposed at an uppermost extent of the at least one upper surface convexity.

### BRIEF DESCRIPTION OF THE FIGURES

The accompanying drawings incorporated in and forming a part of the specification embodies several aspects of the present invention and, together with the description, serve to explain the principles of the invention. In the drawings:

FIG. 1 is a perspective view of a confection shown in accordance with an exemplary embodiment;

FIG. 2 is a side elevation view of the confection shown in FIG. 1;

FIG. 3 is a top plan view of the confection shown in FIG. 1, the bottom view being a mirror image thereof in an exemplary embodiment;

FIG. 4 is a perspective view of a confection shown in accordance with another exemplary embodiment;

FIG. 5 is a side elevation view of the confection shown in FIG. 4;

FIG. 6 is a top plan view of the confection shown in FIG. 4, the bottom view being a mirror image thereof in an exemplary embodiment; and

FIG. 7 is a perspective view of a confection shown in accordance with another exemplary embodiment.

### DETAILED DESCRIPTION

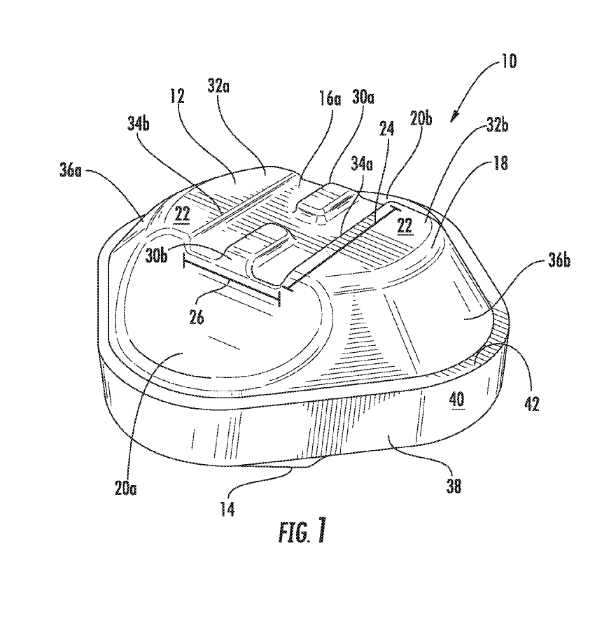

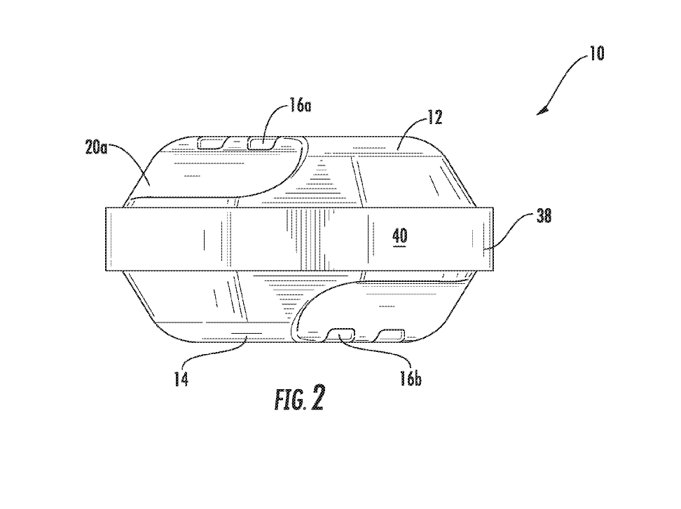

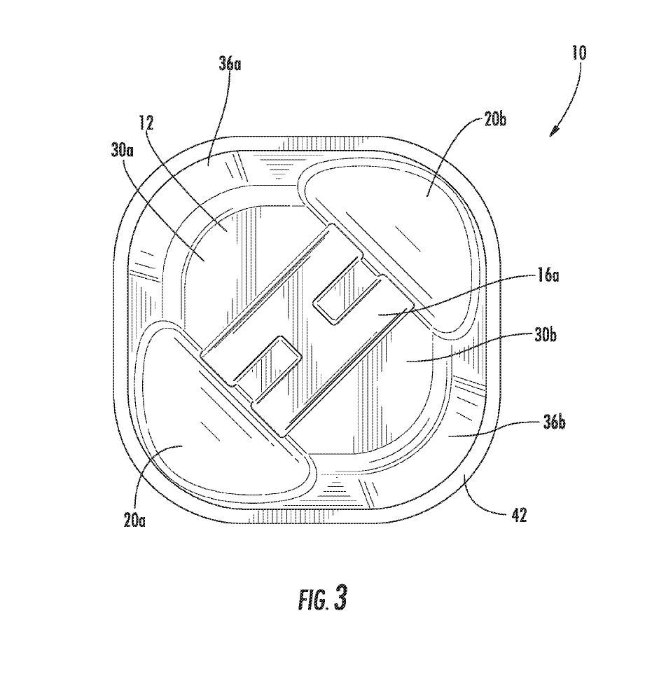

Referring to FIGS. 1-3 a confection 10 in accordance with an exemplary embodiment is shown. The confection 10 as shown, which may be a hard boiled type candy or lozenge that is processed using an extruder or batch former, sizing wheels, and a chain or rotary die, includes an upper surface 12 and a lower surface 14. The confection also includes at least one indicium 16a, 16b (that may be alphanumeric) disposed at one or both of the upper and lower surfaces 12, 14.

As shown in FIGS. 1-3, the upper surface 12 includes a convexity 18 directed away from the lower surface 14 and concavities or gripping depressions 20a, 20b directed towards the lower surface 14. As defined herein, the term convexity is not intended to require an arcuate surface(s). Indeed, the convexities as discussed herein may include arcuate surfaces and/or surfaces with angled changes in directions that create relatively raised features. For purposes of this disclosure, the term convexity merely represents a feature raised from a surface, whereby the raised feature includes any uniform or non-uniform, symmetrical or asymmetrical, curved and/or non-curved shape (inclusive of any curvatures or angles). In addition and as defined herein, the term concavity is not intended to require an arcuate surface(s). Indeed, the concavities as discussed herein may include arcuate surfaces and/or surfaces with angled changes in directions that create relatively depressed features. For purposes of this disclosure, the term concavity merely represents an indentation or depression into a surface, whereby the depression includes any uniform or non-uniform, symmetrical or asymmetrical, curved and/or non-curved shape (inclusive of any curvatures or angles).

The concavities 20a, 20b are disposed proximate opposing edges (more particularly corners) of the confection 10. The convexity 18 is essentially truncated to include a plateau surface 22, upon which the indicium 16a is disposed. In the exemplary embodiment of FIGS. 1-3 the indicium 16a is embossed into the plateau surface 22, perhaps via a forming or depressing of the indicium 16a into the plateau surface 22 while the confection is in a relatively viscous state. The indicium 16a includes a length 24 and a width 26, wherein the length 24 is greater than the width 26, and the length 24 is oriented in a direction towards the concavities 20a, 20b. That is, the concavities 20a and 20b are disposed at opposing short ends 30a, 30b of the indicium 16a and, in an exemplary embodiment, the indicium 16a optionally terminates at one or both concavities 20a. 20b with the embossed impression of the indicium 16a being disposed in fluid communication with one or both concavities 20a, 20b.

As is also shown in FIGS. 1-3 (FIG. 1 in particular), the plateau surface 22 includes non-indicium areas 32a. 32b disposed at opposite sides 34a. 34b of the indicium 16a as separated by the width 26. That is, these non-indicium areas 32a, 32b are disposed at opposing long ends 34a, 34b of the indicium 16a. As shown in the Figures, these areas 32a, 32b of level or co-planar with each other (i.e. equidistant in the height dimension from any point on the lower surface 14) and disposed between the indicium 16a and a relatively downward slope 36a, 36b of the upper surface convexity 18.

In addition to the above discussed features, the confection 10 also includes a band 38 that delimits the upper surface 12 from the lower surface 14. The band 38 includes a relatively vertical band face 40 that runs substantially orthogonal to at least a portion of the upper surface 12 and at least a portion of the lower surface 14. In the exemplary embodiment shown in the Figures, the band 38 extends around a substantial entirety of a perimeter of the confection 10.

As shown in FIGS. 1-3, the band face 40 of the band 38 includes an uppermost extent or edge 42. This edge 42 is disposed closer than or the same distance to the lower surface 14 than a lowermost extent of the concavities 20a. 20b. That is, the uppermost extent 42 of the band face 40 is disposed at a height lower than or equal to the deepest portion of the concavities 20a, 20b.

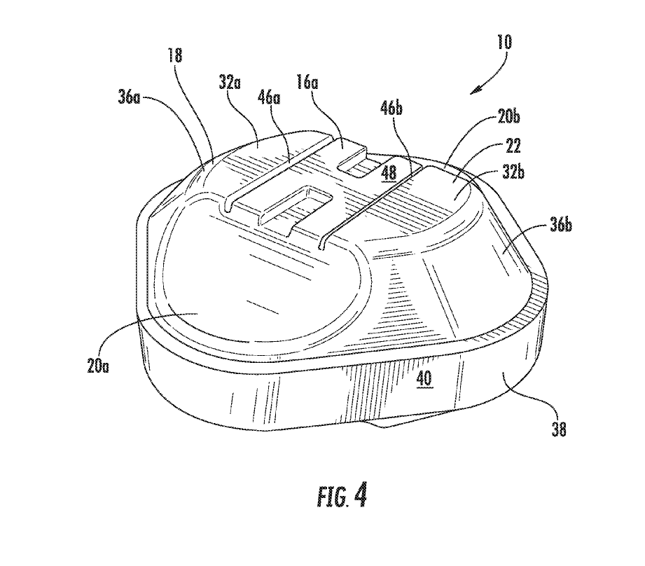

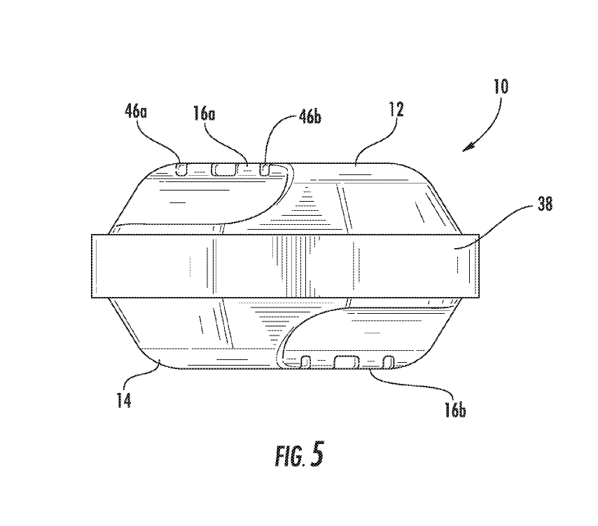

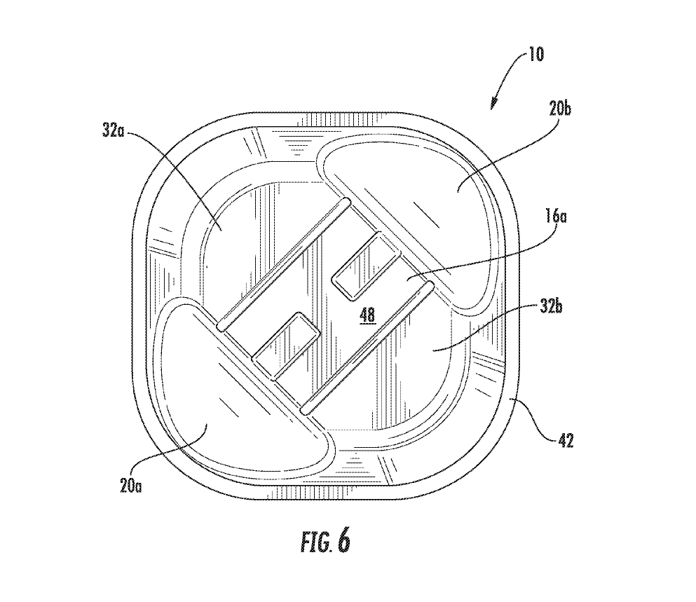

Referring now to the exemplary embodiment shown in FIGS. 4-6, the confection 10 as illustrated includes some of the same and similar features to those mentioned above. These features are numbered accordingly. However, the exemplary embodiment shown in FIGS. 4-6 also includes additional features that will be discussed hereinbelow.

Indeed, as shown best in FIG. 4, the convexity 18 includes grooves 46a. 46b that delimit the indicium 16a from the non-indicium areas 32a, 32b of the plateau surface 22. These grooves 46a, 46b allow the indicium 16a to be defined while including a relatively raised surface 48, at least an uppermost area of which being level or co-planar with both of the non-indicium areas 32a. 32b (i.e. equidistant in the height dimension from any point on the lower surface 14). It should be appreciated that at least 40-50% of said at least one indicium 16a shown in FIGS. 4-6 is at a substantially equal height as the non-indicium areas 32a, 32b.

As is also shown in the exemplary embodiment of FIG. 4, the grooves 46a, 46b are associated with the concavities 20a, 20b. Each of the grooves 46a, 46b and concavities 20a, 20b are disposed at one of the four sides of the indicium 16a (two each for the grooves 46a. 46b and concavities 20a, 20b), such that the grooves 46a, 46b join with the concavities 20a. 20b to effectively form a perimetric depression of varying depth disposed around the indicium 16a. While this depression is continuous and completely encloses the indicium 16a as shown in the Figures, it should be appreciated that a perimetric depression with breaks anywhere along the grooves 46a, 46b or concavities 20a. 20b is within the scope of this disclosure. The concavities 20a, 20b may be disposed at edges or more specifically relative corners of the confection 10, so as to desirably create a pleasing appearance with gripping indentation configurable with a user's thumb or finger. Additional grooves such as 46a. 46b may also be disposed in the plateau 22 or concavities 20a, 20b, such that the indicium is surrounded continuously or discontinuously by grooves on four sides (i.e. all sides depending on the type of indicium).

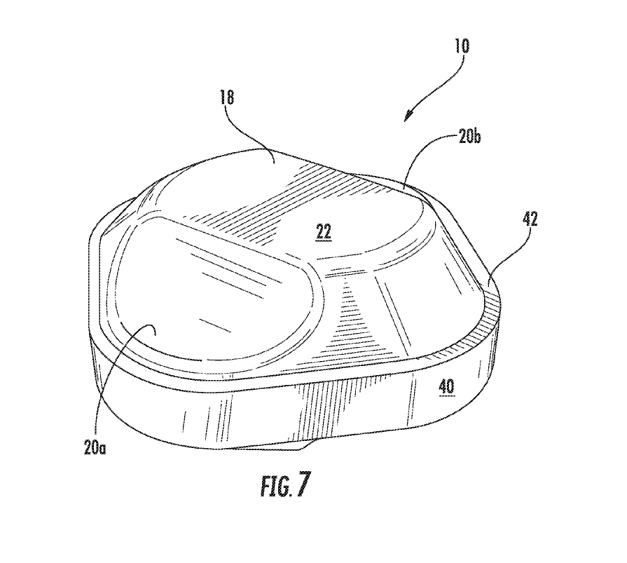

Referring now to the exemplary embodiment shown in FIG. 7, the confection 10 as illustrated includes some of the same and similar features to those mentioned above with reference to FIGS. 1-3 and 4-6. These features are numbered accordingly. However, the exemplary embodiment shown in FIG. 7 also includes additional features that will be discussed hereinbelow.

Indeed, the exemplary embodiment shown in FIG. 7 shows a confection 10 with an upper plateau surface 22 that is absent any indicia. In this exemplary embodiment, the convexity 18 is truncated such that, similar to FIGS. 1-6, the plateau surface 22 is disposed at an uppermost extent of the convexity 18. Of course, at least one indicium such as 16a may be disposed in this area in a manner such as but not limited to those shown in FIGS. 1-6.

For purposes of clarity, the above discussion around the exemplary embodiments shown in FIGS. 1-7 is limited to features disposed on the upper surface 12 of the confection 10. However, it should be appreciated that each of these features discussed as being present or potentially/optionally present on the upper surface 12 may be present on the lower surface 14 as reflected in the Figures. Indeed, the upper and lower surfaces 12, 14 may be symmetrical. Presence of the same features at both the upper and lower surfaces may be beneficial to stacking of the confection 10, and prevent interlocking of the pieces when stacking is attempted. Via such features on the upper and lower surfaces 12, 14, the confection pieces 10 are stackable without outer support at least 5 pieces high in any horizontal orientation of the band 40, particularly whereby the sides of band 40 line up with bands of the confection stacked above and/or below.

In addition, it should be appreciated that when either the upper or lower surface 12, 14 of the confection 10 (if that surface is inclusive of the above discussed features) is placed on a relatively flat surface, the confection 10 is rotatable at least 20 degrees when either opposing surface concavity is pressed down upon.

In each of the above discussed embodiments, it should be appreciated that the plateau surface 22 may occupy at least 10-20% (and more particularly 10-15% or 11%) of the upper surface 12 of the confection 10, or at least 10-20% (and more particularly 10-15% or 11%) of the upper surface 12 of the confection 10 minus any surface area occupied by any indicium 16a. In addition, the plateau surface 22 may be disposed at least 0.1 inches above an uppermost extent of the band 40 or edge 42.

As is alluded to above, the concavities 20a, 20b create a gripping utility and pleasing appearance in the confection 10. These concavities in conjunction with a confection including indicia (or simply without sufficient presence an appropriately positioned flat surface area) can create difficulties in stacking the confection pieces 10 in any orientation or rotation without innovation such as but not limited to positioning and configuration of the indicia 16a (and perhaps 16b) and truncation of the convexity 18 to include a plateau surface(s). As discussed in the above exemplary embodiments, these difficulties may be addressed via the level surface area provided by the non-planar areas of FIGS. 1-3, the non-planar areas and raised surface of the indicium in FIGS. 4-6, or simply the completely flat surface without indicia in FIG. 7.

Some other advantages of the confection 10 as discussed above and shown in FIGS. 1-6 include a decrease in confection waste (e.g. less dust and chipping during manufacture), fewer instances of doubles resulting from pieces sticking together, and a greater efficiency in feed to roll wrappers used to wrap the confection 10. With reference to the decrease in confection waste, manufacture of the confection 10 as discussed above and shown in FIGS. 1-6 resulted in a 70-80% reduction in floor scrap (more particularly 75-80% or 78%), a 40-50% reduction in candy scrap (more particularly 45-50% or 46%), a 20-30% reduction in feed plate scrap (more particularly 20-25% or 20%), a 70-80% reduction in stacker scrap (more particularly 75-80% or 80%), a 50-60% reduction in total scrap (more particularly 55-60% or 58%), and a 60-70% reduction in powder in the machine (more particularly 60-65% or 64%). With reference to the instances of doubles resulting from pieces sticking together, manufacture of the confection 10 as discussed above and shown in FIGS. 1-7 resulted in a 90-95% reduction in doubles (more particularly about 92% or 93%). For purposes of this disclosure. “floor scrap” reflects all pieces and material swept up from below the packaging equipment (typically “stick” equipment used for stacked confection), “candy scrap” reflects candy defects removed from the hopper and feed-plate of the packaging equipment, “powder” is what was collected after sweeping all areas below the feed plate, transfer plate, stacker, etc. of the packaging equipment, “feed plate scrap” is the powder and chips collected underneath the feed plate in the collection trough of the packaging equipment, and—“stacker scrap” is the powder and chips collected underneath the stacker reject collection trough of the packaging equipment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having.” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A confection comprising:
a confection body including an upper surface and an opposing lower surface; and
at least one upper surface indicium and at least one upper surface non-indicium area disposed at said upper surface,
wherein an uppermost extent of said at least one upper surface indicium extends a substantially equal distance from said lower surface as an uppermost extent of said at least one upper surface non-indicium area.

2. The confection of claim 1, further including at least one depression into said upper surface, said at least one depression being disposed perimetrically about said upper surface indicium and delimiting said upper surface indicium from said upper surface non-indicium area.

3. The confection of claim 1, wherein said uppermost extent of said at least one upper surface indicium and said uppermost extent of said upper surface non-indicium area extend a greater distance from said lower surface than any other area of said upper surface.

4. The confection of claim 1, wherein said at least one depression is disposed perimetrically about said upper surface indicium at all sides of said upper surface indicium.

5. The confection of claim 1, wherein said at least one depression continuously surrounds said at least one upper surface indicium such that said upper surface indicium is completely enclosed within said at least one depression about a perimeter thereof.

6. The confection of claim 1, wherein said at least one depression includes at least one of a varying depth and width, and wherein at least a portion of said at least one depression extends to an area proximate an edge of said confection body to create a gripping indentation configurable with a user's thumb or finger.

7. (canceled)

8. The confection of claim 1, further including a lower surface indicium and a lower surface non-indicium area disposed at said opposing lower surface; and
at least one depression into said lower surface, said at least one depression being disposed perimetrically about said lower surface indicium and delimiting said lower surface indicium from said lower surface non-indicium area;
wherein a lowermost extent of said at least one lower surface indicium extends a substantially equal distance from said upper surface as a lowermost extent of said lower surface non-indicium area.

9. (canceled)

10. A confection comprising:
a confection body including an upper surface and an opposing lower surface;
at least one upper surface concavity that is concave in a direction towards said lower surface;
at least one upper surface convexity that is convex in a direction away from said lower surface; and
at least one upper surface indicium disposed at a plateau surface of said at least one upper surface convexity, said upper surface indicium including a length and a width, said length of said at least one upper surface indicium being oriented in a direction towards said at least one upper surface concavity, wherein said length of said at least one upper surface indicium is greater than said width of said at least one upper surface indicium.

11. The confection of claim 10, wherein said at least one upper surface concavity is two concavities disposed proximate opposing edges of the confection.

12. The confection of claim 11, wherein said two concavities are disposed at opposing ends of said length of said at least one upper surface indicium.

13. The confection of claim 10, wherein said length of at least one upper surface indicium extends to terminate at said at least one upper surface concavity.

14. (canceled)

15. The confection of claim 10, wherein said plateau surface includes level surfaces at areas disposed at opposite sides of said at least one indicium separated by said width.

16. (canceled)

17. The confection of claim 10, further including at least one lower surface concavity that is concave in a direction towards said upper surface;
at least one lower convexity that is convex in a direction away from said upper surface; and
at least one lower surface indicium disposed at a plateau surface of said at least one lower surface convexity, said at least one lower surface indicium including a length and a width, said length of said at least one lower surface indicium being oriented in a direction towards said at least one lower surface concavity, wherein said length of said at least one lower surface indicium is greater than said width of said at least one lower surface indicium.

18. The confection of claim 15, wherein any non-depressed surface of the indicium is disposed at a height equal to the level surfaces

19. A confection comprising:
a confection body including an upper surface and an opposing lower surface;
at least one upper surface concavity that is concave in a direction towards said lower surface;
at least one upper surface convexity that is convex in a direction away from said lower surface; and
at least one upper surface indicium disposed at a plateau surface of said at least one upper surface convexity, said at least one upper surface indicium including a length and a width, wherein said plateau surface includes level surfaces at areas disposed at opposite sides of said at least one upper surface indicium separated by said width of said at least upper surface one indicium, said level surfaces being disposed at an equal height.

20. The confection of claim 19, wherein said level surfaces are disposed between said at least one upper surface indicium and a relatively downward slope of said at least one upper surface convexity.

21. The confection of claim 19, wherein said level surfaces are disposed at an uppermost extent of the confection.

22. (canceled)

23. A confection comprising:
a confection body including an upper surface and an opposing lower surface;
at least one upper surface concavity that is concave in a direction towards said lower surface;
at least one upper surface convexity that is convex in a direction away from said lower surface; and
at least one upper plateau surface disposed at an uppermost extent of said at least one upper surface convexity.

24. The confection of claim 23, wherein said at least one upper plateau surface occupies at least 10-20% of said upper surface.

25. The confection of claim 23, wherein said at least one upper plateau surface includes at least one upper surface indicium.

26. The confection of claim 25, wherein said at least one upper plateau surface occupies at least 10-20% of said upper surface minus an area occupies by said at least one indicium.

27. The confection of claim 23, further including a perimetric band that delimits said upper surface from said lower surface, said at least one upper plateau surface being disposed at least 0.1 inches above an uppermost extent of said perimetric band.

28. The confection of claim 23, further including at least one lower surface concavity that is concave in a direction towards said upper surface;
at least one lower convexity that is convex in a direction away from said upper surface; and
at least one lower plateau surface disposed at an lowermost extent of said at least one lower surface convexity.

29. The confection of claim 28, wherein said at least one lower plateau surface is disposed at said lowermost extent of said at least one lower surface convexity such that the confection is rotatable at least 20 degrees when the confection is placed on a substantially flat surface and said at least one upper surface concavity is pressed down upon.

30. The confection of claim 1, wherein at least 40-50% of said at least one indicium is at a substantially equal height as said at least one upper plateau surface disposed at said uppermost extent of said at least one upper surface convexity.

31-34. (canceled)
